(19) United States
(12) Patent Application Publication
(10) Pub. No.: US 2012/0086248 A1
(43) Pub. Date: Apr. 12, 2012

(54) WATERPROOF MOTORCYCLE SEAT COVER

(76) Inventor: VINCENT JOSEPH MORABITO, Williamsville, NY (US)

(21) Appl. No.: 13/081,454

(22) Filed: Apr. 6, 2011

Related U.S. Application Data
(60) Provisional application No. 61/391,155, filed on Oct. 8, 2010.

(51) Int. Cl. B60N 2/60

(52) U.S. Cl. 297/219.11; 297/219.1

(57) ABSTRACT

A waterproof motorcycle seat cover may include a stretchable waterproof fabric that may be configured to fit over a motorcycle seat. The waterproof motorcycle seat cover may prevent water from soaking into a motorcycle seat through the seat material or the stitching.

### CROSS-REFERENCE TO RELATED APPLICATION

The present application claims the benefit of U.S. Provisional Application No. 61/337,645, filed Oct. 8 2010, which is incorporated herein by reference.

### BACKGROUND OF THE INVENTION

The present invention generally relates to seat covers and, more particularly, to a waterproof motorcycle seat cover which prevents water from soaking into a motorcycle seat through the seat material or the stitching.

Motorcycle seats are commonly exposed to the elements when a motorcycle is parked in an unprotected location. By leaving the motorcycle seat in an unprotected environment, the seat is subject to significant deterioration as a result of this exposure. In addition to damage to the seat, a rider may experience significant discomfort or inconvenience when the seat becomes wet from precipitation. It is therefore desirable to protect the seat from the elements.

As can be seen, there may be a need for a waterproof motorcycle seat cover which prevents water from soaking into motorcycle seats.

### SUMMARY OF THE INVENTION

In one aspect of the present invention a seat cover comprises a waterproof fabric configured to stretch and fit over a seat.

These and other features, aspects and advantages of the present invention will become better understood with reference to the following drawings, description and claims.

### BRIEF DESCRIPTION OF THE DRAWINGS

FIG. 1 is a perspective view of a motorcycle seat cover according to an embodiment of the present invention, in use;

FIG. 2 is an exploded perspective view of the motorcycle seat cover of FIG. 1;

FIG. 3 is a plan view of the motorcycle seat cover of FIG. 1;

FIG. 4 is a cross section view of the motorcycle seat cover taken along line 4-4 in FIG. 3;

FIG. 5 shows a plan view of a motorcycle seat cover according to another embodiment of the present invention;

FIG. 6 shows a plan view of a motorcycle seat cover according to yet another embodiment of the present invention; and

FIG. 7 shows a plan view of a motorcycle seat cover according to still another embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an exemplary embodiment of the present invention provides a waterproof motorcycle seat cover. The waterproof motorcycle seat cover may prevent water from soaking into a motorcycle seat through the seat material or the stitching. The stretched motorcycle seat cover may follow the contours of the motorcycle seat without gathering the fabric of the motorcycle seat cover, which may make the motorcycle seat comfortable for a rider as there is no overlapped fabric for the rider to sit on or flap in the wind.

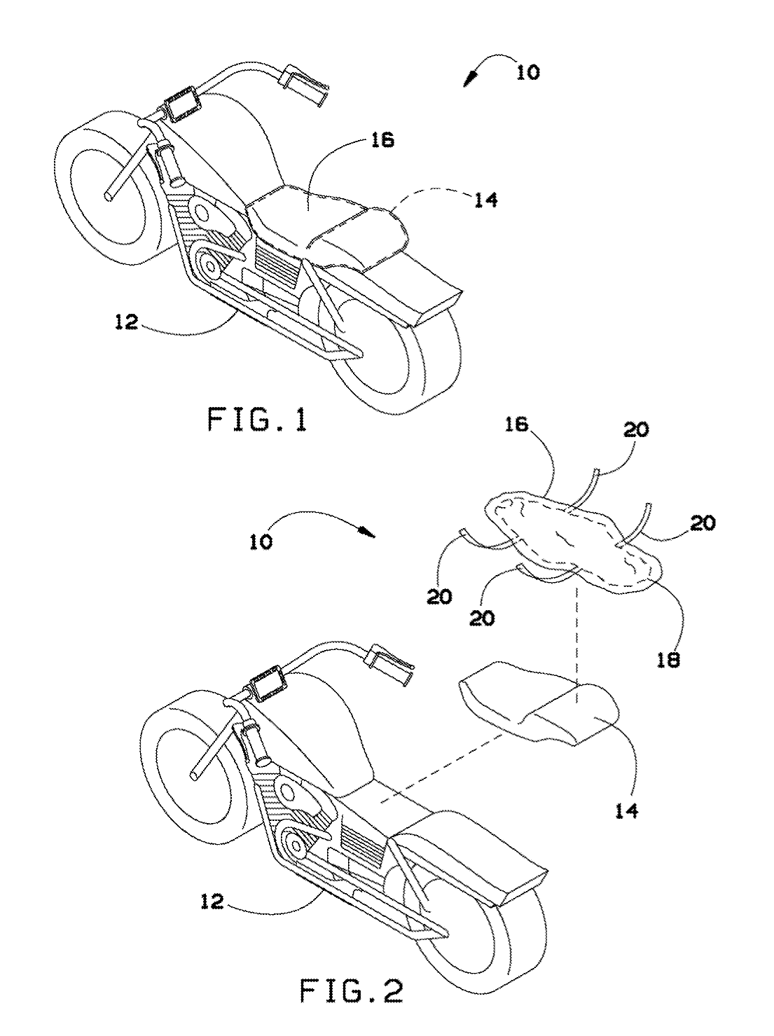

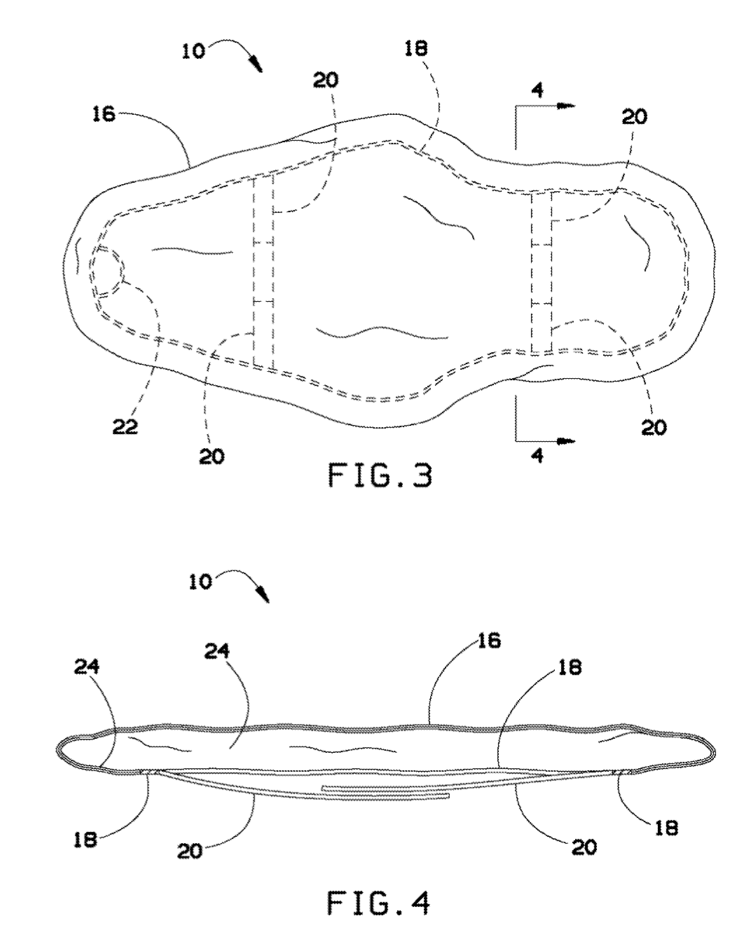

Referring now to FIGS. 1-4, different views of a waterproof motorcycle seat cover 10 are shown according to exemplary embodiments of the present invention. The motorcycle seat cover 10 may be designed for a two-up seat (also referred to as a pillion seat), which may carry both a driver and/or a passenger. The motorcycle seat cover 10 may include a stretchable fabric 16, for example, Lycra® fabric, a waterproof membrane 24, an elastic securing loop 22, and a peripheral elastic band 18. The stretchable waterproof membrane 24 may be bonded to the underside the stretchable fabric 16 to make the motorcycle seat cover 10 waterproof. The elastic band 18 may be stitched on and around the perimeter of the motorcycle seat cover 10, typically the entire perimeter of the motorcycle seat cover 10, by an elastic thread. The elastic securing loop 22 may be formed close to a forward end of the motorcycle seat cover 10. Two or more straps 20, for example, hook and loop fastener straps, may be attached to the underside of the motorcycle seat cover 10 to secure the motorcycle seat cover 10 to the seat 14 of a motorcycle 12.

Referring now to FIG. 5, a plan of the waterproof motorcycle seat covers 30 is shown according to another exemplary embodiment of the present invention. The motorcycle seat cover 30 may be designed for a seat with a backrest. The motorcycle seat cover 30 may include the stretchable fabric 16, the waterproof membrane 24, the elastic securing loop 22, and the peripheral elastic band 18. The stretchable waterproof membrane 24 may be bonded to the underside the stretchable fabric 16 to make the motorcycle seat cover 30 waterproof. The elastic band 18 may be stitched on and around the perimeter of the motorcycle seat cover 30 by the elastic thread. The elastic securing loop 22 may be formed close to the forward end of the motorcycle seat cover 30. Two or more straps 20 may be attached to the underside of the motorcycle seat cover 30. A back rest split 26 may be formed in the fabric 16 to fit the motorcycle seat cover 30 to certain types of seats.

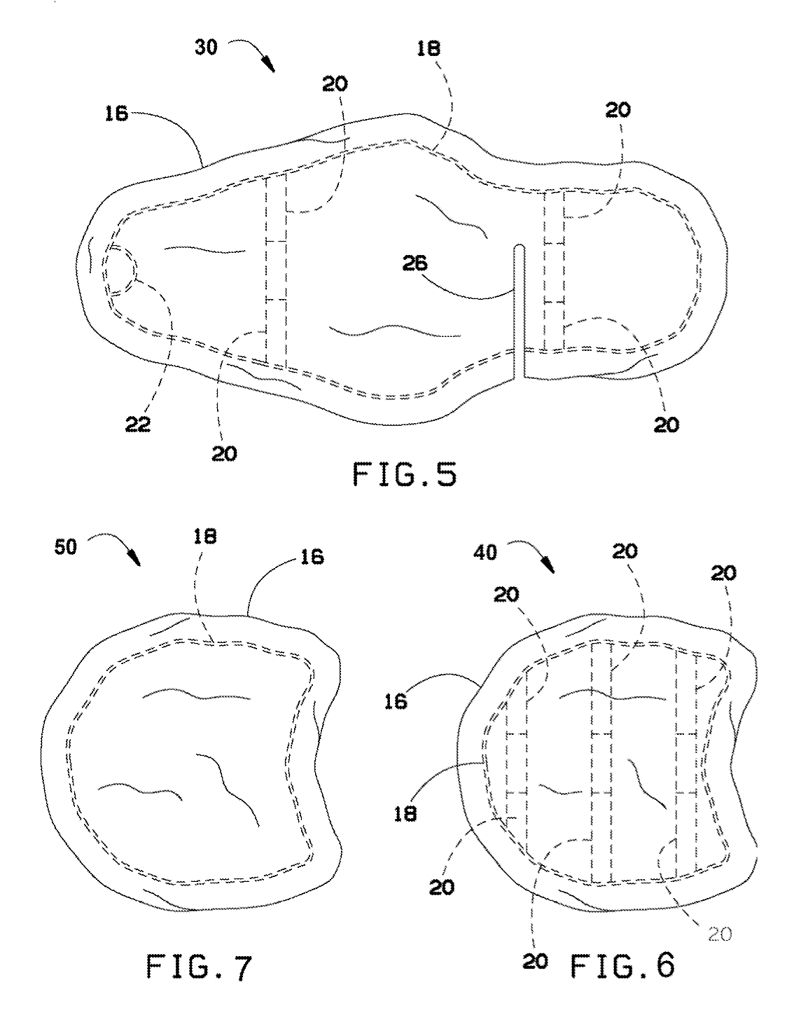

Referring now to FIG. 6, a plan view of a waterproof motorcycle seat cover 40 is shown according to yet another exemplary embodiment of the present invention. The waterproof motorcycle seat cover 40 designed for a solo seat. The solo seat may carry the driver alone. The waterproof motorcycle seat cover 40 may include the stretchable fabric 16, the waterproof membrane 24, and the peripheral elastic band 18. The stretchable waterproof membrane 24 may be bonded to the underside of the stretchable fabric 16. The elastic band 18 may be stitched on and around the perimeter of the motorcycle seat cover 40 by the elastic thread. Two or more straps 20 may be attached to the underside of the motorcycle seat cover 40.

Referring now to FIG. 7, a plan view of a waterproof motorcycle seat cover 50 is shown according to still another exemplary embodiment of the present invention. The waterproof motorcycle seat cover 50 is a modified implementation of the waterproof motorcycle seat cover 40. The waterproof motorcycle seat cover 50 may share all of the features of the waterproof motorcycle seat cover 40 with the exception that there may be no straps 20 included.

The motorcycle seat covers 10, 30, 40 and 50 may be manufactured to have their overall sizes about 5% smaller than the sizes of seats upon which they may be applied. Once applied, the stretched out motorcycle seat covers 10, 30, 40 and 50 may follow the contours of the seat to fit and provide water tight seals over the seat.

The motorcycle seat cover 10, 30 or 50 may be applied by removing the existing seat 14 from the motorcycle 12, hooking the elastic securing loops 22, if there are any, to the seat 14, stretching the motorcycle seat cover 10, 30 or 50 over the seat 14, and reattaching the seat 14 to the motorcycle 12. The motorcycle seat cover 40 may be applied by stretching the seat cover 40 over the seat 14 of the motorcycle 12.

The motorcycle seat covers 10, 30, 40 and 50 may work by providing a barrier between the elements and the seat 14 of the motorcycle 12 in a form fitting way due to the nature of the material of the motorcycle seat covers.

It should be understood, of course, that the foregoing relates to exemplary embodiments of the invention and that modifications may be made without departing from the spirit and scope of the invention as set forth in the following claims.

What is claimed is:

1. A seat cover, comprising:
a waterproof fabric configured to stretch and fit over a seat.

2. The seat cover of claim 1, wherein the seat is a motorcycle seat.

3. The seat cover of claim 1, wherein the waterproof fabric includes a stretchable waterproof membrane bonded to an underside of a stretchable fabric.

4. The seat cover of claim 3, wherein the waterproof fabric is stretchable.

5. The seat cover of claim 1 further including an elastic band stitched on and around a perimeter of the seat cover by an elastic thread.

6. The seat cover of claim 1, further including a securing loop attached to the waterproof fabric to hook the seat cover to the seat.

7. The seat cover of claim 6, wherein the securing loop is made from an elastic material.

8. The seat cover of claim 1, further including at least two straps attached to the waterproof fabric to secure the seat cover to the motorcycle seat.

9. The seat cover of claim 8, wherein the straps are loop and hook fasteners.

10. The seat cover of claim 1, further including a back rest split formed in the waterproof fabric.
